(19) United States
(12) Patent Application Publication
(10) Pub. No.: US 2014/0104293 A1
(43) Pub. Date: Apr. 17, 2014

(54) AMBIENT LIGHT EFFECT IN VIDEO GAMING

(71) Applicants: Adam Li, Solana Beach, CA (US); Megan Farrell, San Diego, CA (US); Aixin Liu, San Diego, CA (US); Djung Nguyen, San Diego, CA (US)

(72) Inventors: Adam Li, Solana Beach, CA (US); Megan Farrell, San Diego, CA (US); Aixin Liu, San Diego, CA (US); Djung Nguyen, San Diego, CA (US)

(21) Appl. No.: 13/654,272

(22) Filed: Oct. 17, 2012

(51) Int. Cl. G09G 5/02

(52) U.S. Cl. 345/589

(57) ABSTRACT

A system and method for controlling ambient light effects in video gaming are provided. The system includes a gaming device including at least one processor programmed to parse incoming video game content to detect at least one portion of the video game content and determine at least one ambient light effect to be associated with the at least one portion of the video game content. The system also includes at least one lighting device in communication with the gaming device. The processor of the gaming device is programmed to send a command from the gaming device to the at least one lighting device to specify at least one ambient light effect determined by the at least one processor to be associated with the at least one portion of the video content. After receiving the command, the at least one lighting device generates the specified ambient light effect.

### FIELD

This invention relates to ambient light effects, and more specifically, to ambient light effects generated based on information included in a video file.

### BACKGROUND

Video games can provide visual stimulation from a television screen display and audio stimulation from the speakers connected to the television. There are some known systems that attempt to enhance a viewer's/user's experience by providing a more interactive/responsive environment. For example, some video gaming systems cause lighting devices such as lamps to generate an ambient light effect (“ALE”) during game play.

To provide an enjoyable interactive experience, the lighting devices need connected to the video game systems to generate the ambient light effects at appropriate times when the associated video game content is displayed to a user. In addition, the lighting devices need to generate a variety of ambient light effects to appropriately match a variety of scenes and action sequences in a video game. Thus, an ambient light effect-capable system needs to be able to identify one or more scenes during the display of which an ambient light effect is to be generated.

One such gaming system focuses on detecting and analyzing various parameters of the video game application and generating ambient light effects based on the detected parameters. One problem with such an approach is that many video games include various access restrictions imposed by the content providers, and such restrictions may make it difficult or impossible to analyze the parameters of a video file and/or video game.

Some existing gaming systems include lighting devices that produce only various intensities and flickering of white colored light. A disadvantage of such systems is that while the video games typically include a wide variety of scenes, events, and action sequences, some of the known ambient light systems are limited to generating a single light color which may appear too repetitive to users and cause the users to lose interest in such ambient light effects.

Accordingly, what is needed is a way of producing ambient light effects in association with one or more portions of a video file that overcomes the aforementioned shortcomings.

### SUMMARY

The present invention satisfies this need. In one embodiment, a method of controlling ambient light effects in video gaming is provided. The method comprises: providing a gaming device configured to parse incoming video game content; receiving the video game content at the gaming device, the video game content including at least one track specifying at least one ambient light effect associated with at least one portion of the video game content; parsing the video game content at the gaming device to separate the at least one track specifying the at least one ambient light effect and the at least one lighting device; sending a command to generate the at least one ambient light effect specified in the at least one track from the gaming device to the at least one lighting device specified in the at least one track; and causing the at least one lighting device receiving the command to generate the at least one ambient light effect specified in the at least one track when the at least one portion of the video game content associated with the at least one ambient light effect is displayed to a user.

In one approach, the gaming device is selected from one of a game console, a personal computer, a laptop computer, a tablet computer, and a mobile phone.

In one approach, the gaming device includes at least one hardware component programmed to parse the video game content to separate the at least one track specifying the at least one ambient light effect. In another approach, the gaming device includes at least one software component adapted for inserting the at least one track specifying the at least one ambient light effect into the video game content.

In one approach, the at least one track further includes a predetermined location of the at least one lighting device relative to the gaming device. In another approach, the at least one track includes a predetermined time when the at least one ambient light effect is to be generated by the at least one lighting device. In another approach, the at least one track includes at least one of brightness and rate of flickering of the at least one ambient light effect to be generated by the at least one lighting device.

In one approach, the at least one portion of the video game content is a predetermined event in a video contained in the video game content and the predetermined event is associated with the at least one ambient light effect.

In one approach, the method includes providing a graphical user interface permitting a user to configure one or more options for controlling generation, by the at least one lighting device, of the at least one ambient light effect included in the at least one track.

In one approach, the method further comprises sending the command from the gaming device to the at least one lighting device via a wired connection.

In another approach, the method further comprises sending the command from the gaming device to the at least one lighting device via a wireless connection. In yet another approach, the method further comprises sending the command from the gaming device to the at least one lighting device via a home automation system.

A method of producing an ambient light effect in video gaming is provided. The method comprises: providing a gaming device including a processor programmed to parse incoming video game content; receiving the video game content including a plurality of scenes at the gaming device; parsing the incoming video game content and detecting at least one scene in the video game content; generating a command at the gaming device specifying the at least one ambient light effect to be associated with the at least one scene; and sending the command from the gaming device to the at least one lighting device in communication with the gaming device to generate the at least one ambient light effect associated with the at least one scene when the at least one scene is displayed to a user.

In one approach, the method includes detecting at least one scene having a brightness level exceeding a predetermined threshold. In another approach, the method further includes detecting at least one scene having a brightness level below a predetermined threshold. In yet another approach, the method further includes detecting at least one scene having a sound level exceeding a predetermined threshold. In still another approach, the method includes detecting at least one scene having a sound level below a predetermined threshold. In still another approach, the method includes detecting an action in the at least one scene predetermined to be associated with the at least one ambient light effect.

In an approach, the method further comprises including in the command chrominance control data specifying at least one color selected from red, green, blue, or combinations thereof to be generated by the at least one lighting device. In one approach, the method further comprises specifying the at least one lighting device for generating the at least one ambient light effect associated with the at least one scene of the video game content.

### BRIEF DESCRIPTION OF THE DRAWINGS

FIG. 1 is a front view of several exemplary devices for performing a method according to one embodiment;

FIG. 2 is a schematic diagram of several exemplary devices for performing a method according to yet another embodiment; and

FIG. 3 is a schematic diagram illustrating an exemplary video stream and several devices for performing a method according to yet another embodiment.

FIG. 4 is a schematic diagram illustrating another exemplary video stream and several devices for performing a method according to yet another embodiment

### DETAILED DESCRIPTION

Reference will now be made in detail to the present preferred embodiments of the invention, examples of which are illustrated in the accompanying drawings.

Generally, systems and methods are described herein for providing ambient light effects for a user when playing video games. The ambient light effects can be generated by one or more lighting devices based on information included as additional tracks in the video game content. The ambient light effects can be associated with various events or action sequences in the video game, and can be customized by the user through an interactive graphical user interface.

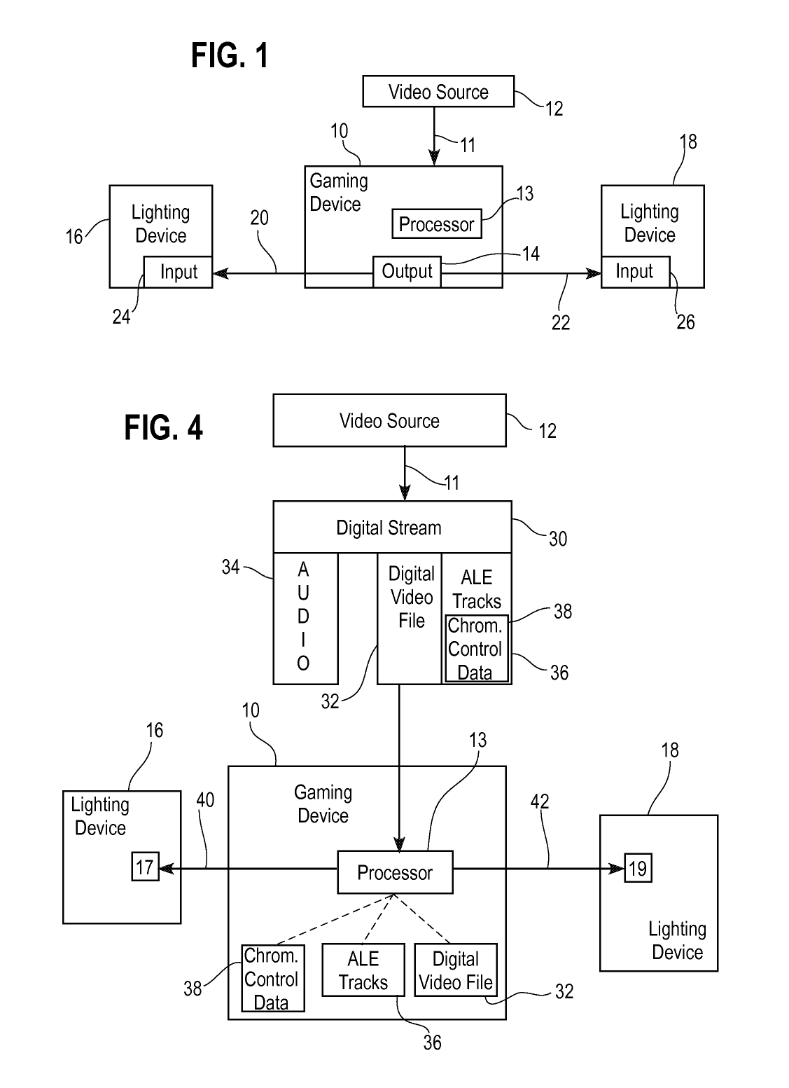

With specific reference to FIG. 1, in one embodiment of a method of controlling ambient light effects, a gaming device 10 receives video game content a video source 12 via a connection 13. The gaming device 10 can be any one of a game console, a personal computer, a laptop computer, a tablet computer, a mobile phone, or the like.

The video source 12 can be any source capable of providing video game content to via a connection 11 to the gaming device 10. The video source 12 can be a video game disc, a hard drive, or a digital media server capable of streaming video game content to the gaming device 10. Although the gaming device 10 preferably receives the video game content from the video source 12 via a wired connection 11, the connection 11 between the gaming device 10 and the video source 12 can also be wireless.

In one approach shown in FIG. 1, the gaming device 10 is directly connected to two lighting devices 16 and 18 via connections 20 and 22, respectively. The gaming device 10 has an output 14 and the lighting devices 16 and 18 each have an input 24 and 26, respectively, which can be interconnected via the respective connections 20 and 22. It is to be appreciated that the connections 20 and 22 can be either wired or wireless connections, and the gaming device 10 and the lighting devices 16 and 18 can be connected as described in more detail in co-pending application entitled “VIDEO FILES INCLUDING AMBIENT LIGHT EFFECTS,” filed on Oct. 17, 2012, the entire disclosure of which is incorporated by reference herein.

The lighting devices 16 and 18 can be any type of household or commercial device capable of producing visible light. For example only, the lighting devices 16, 18 may be stand-alone lamps, track lights, recessed lights, wall-mounted lights or the like. In one approach, the lighting devices 16 and 18 are capable of generating light having color based on the RGB model or any other visible colored light in addition to white light. In another approach, the lighting devices 16 and 18 are also adapted to be dimmed.

The gaming device 10 has been shown in FIG. 1 as being connected to two lighting devices 16 and 18 by way of example only, and it will be appreciated that that the gaming device 10 can be connected to any number of lighting devices 16 and 18 suitable for a given room where the gaming device 10 is located.

In one exemplary approach, the gaming device 10 may be connected to only one lighting device 16. In another approach, the gaming device 10 may be connected to four lighting devices each located in a corner of a room, in another approach, the gaming device 10 may be connected to at least two lighting devices located in front of a user, at least two lighting devices located on right and left sides of the user, and at least two lighting devices located behind the user so as to create a surround ambient light effect for the user. It is to be appreciated that the lighting devices 16 and 18 can be identical to each other, or can be different such that the gaming device 10 can be simultaneously connected to two, three, four, or more types of different lighting devices.

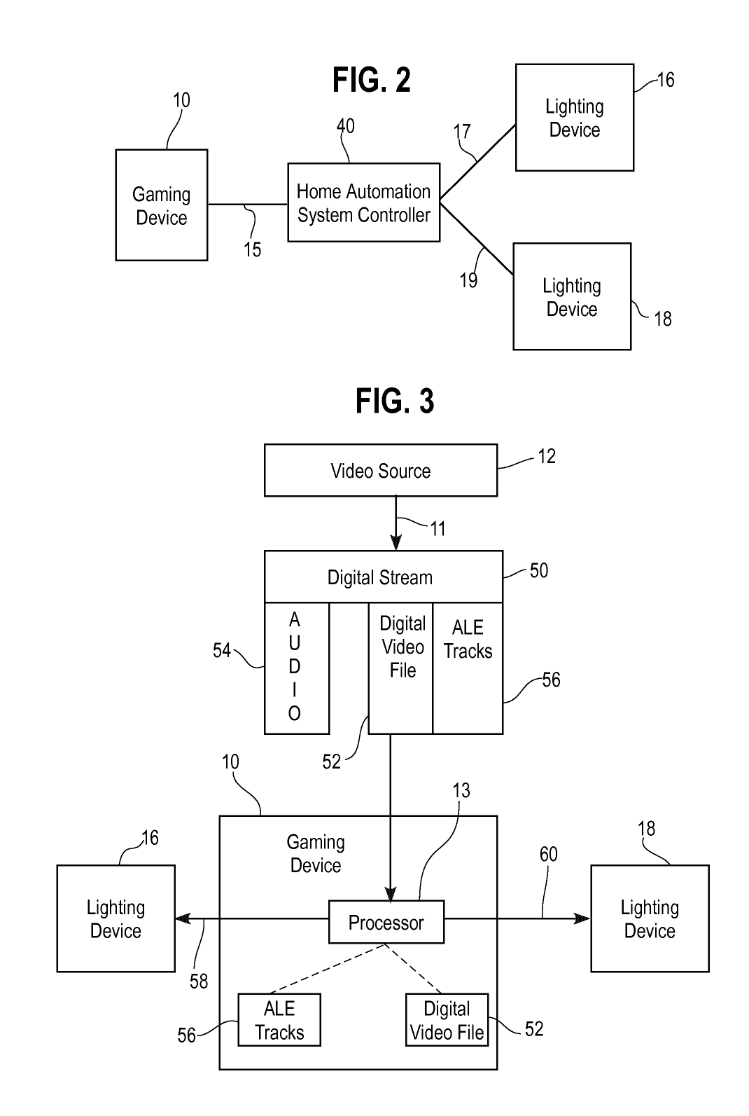

In one approach shown in FIG. 2, the gaming device 10 can be indirectly connected to the two lighting devices 16 and 18 via a home automation system controller 40. The home automation system controller 40 can be a physical device adapted to control the lighting devices 16 and 18 and other household devices. In one approach shown in FIG. 3, the home automation system controller 40 is located separate from the gaming device 10 and connected to the gaming device 10 via a connection 15. The home automation controller 15 is in turn connected to the lighting devices 16 and 18 via connections 17 and 19, respectively. The connections 15, 17 and 19 can be wired or wireless connections. In another approach, the home automation controller 40 can be integrated into the gaming device 10. In one approach, the home automation controller 40 may provide a graphical user interface to a user, for example, on a display connected to the gaming device 10 to permit the user to control and customize various aspects of the ambient light effects.

The lighting devices 16 and 18 can be any type of household or commercial devices capable of producing visible light. For example only, the lighting devices 16 and 18 may be stand-alone lamps, track lights, recessed lights, wall-mounted lights or the like. The lighting devices 116 and 18 are preferably adapted to be dimmed. The lighting devices 16 and 18 have been shown in FIG. 1 as being identical for example only, and it is to be appreciated that the gaming device 10 can be simultaneously connected to two, three, four, or more types of different lighting devices.

Further, it is to be appreciated that the gaming device 10 has been shown in FIG. 1 as being connected to two lighting devices 16 and 18 by way of example only, and that the gaming device 10 can be connected to any number of lighting devices suitable for a given room where the gaming device 10 is located. In one exemplary approach, the gaming device 10 may be connected to only one lighting device. In another approach, the gaming device 10 may be connected to four lighting devices each located in a corner of a room. In another approach, the gaming device 10 may be connected to at least two lighting devices located in front of a user, at least two lighting devices located on right and left sides of the user, and at least two lighting devices located behind the user so as to create a surround ambient light effect for the user.

With reference to FIG. 3, the gaming device 10 is adapted for parsing video game content incoming from the video source 12. For example only, the gaming device 10 may include a processor 13 that is programmed to parse the incoming video game content. For purposes of this application, the term “processor” will be understood to mean any hardware component capable of parsing the incoming video game content and digital video files contained in the video game content. For example, the processor 13 may be a graphics card, a decoder, or the like.

FIG. 3 shows an exemplary digital video stream 50 representing video game content incoming from the video source 12 and being received by the gaming device 10. The digital video stream 50 of the video game content includes a digital video file 52 and a digital audio file 54. The digital video stream 50 of the video game content also includes additional ALE tracks 56 including data specifying at least one ambient light effect associated with one or more portions, scenes, or action sequences contained in the digital video file 52 of the video game content. The ALE tracks 56 can also include data specifying at least one lighting device (e.g., 16, 18, or both) for generating the at least one ambient light effect specified in the ALE tracks 56.

When the digital video stream 50 is received by the gaming device 10 from the video source 12, the processor 13 of the gaming device 10 performs the parsing of the digital video file 52 of the video game content to separate one or more ALE tracks 56 and detect data representing one or more ambient light effects included in the ALE tracks 56. The processor 13 of the gaming device 10 is also programmed to produce and send one or more commands to one or more lighting devices 16, 18 to generate the one or more ambient light effects specified in one or more ALE tracks 56. For example only, the processor 13 can cause the gaming device 10 to send a first command 58 to the lighting device 16 to generate a first ambient light effect specified in the ALE track 56 and send a second command 60 to the lighting device 18 to generate a second ambient light effect specified in the ALE track 56. The first and second ambient light effects may be the same or different.

The receipt of the commands 58 and 60 by the lighting devices 16 and 18 causes the lighting devices 16 and 18 to generate the ambient light effects specified in the commands 58 and 60. The ambient light effects specified in the ALE tracks 56 are then generated by the lighting devices 16 and 18, preferably when the one or more portions of the digital video file 52 of the video game content associated with one or more ambient light effects specified in the ALE tracks 56 are displayed to the user. The generation of the ambient light effects by the lighting devices 16 and 18 in association with scenes, action sequences, or events specified in the ALE tracks 56 creates an enhanced and visually pleasing experience for a user watching a television program, a movie, or playing a video game.

In one approach, each of the ALE tracks 56 can also include an identification of the lighting device (e.g., 16, 18, or both) to generate the ambient light effect specified in the ALE track 56. In particular, the ALE tracks 56 can specify a predetermined location of the lighting device for generating the ambient light effect relative to the gaming device 10. By way of example only, if the user is playing a first-person-shooter video game and the user's character gets shot at from behind or the side, the ALE track 56 can specify that a lighting device located behind or on the side of the user generate the ambient light effect specified in the ALE track 56 for such a shooting attack.

In one approach, each of the ALE tracks 56 can also include a predetermined time when the at least one ambient light effect specified in a respective ALE track 56 is to be generated by a lighting device specified in the respective ALE track 56. By way of example only, the predetermined time may be set such that the ambient light effect is generated by an appropriate lighting device not only while the scene or event in the video game contained in the video file 52 is displayed to the user, but where appropriate, last an additional one or two seconds more after the scene or event is no longer displayed to the user.

In another approach, each of the ALE tracks 56 can also include data specifying brightness of the ambient light effect to be generated by one or more lighting device. By way of example, an ambient light effect generated during the display of a video game scene showing mid-day sunlight can be visibly brighter to a user than an ambient light effect generated during the display of a scene taking place at dusk or dawn.

The ambient light effects specified in the ALE tracks 56 can be associated with any portion of the video file 52 of the video game content. For example, portions of the video file 52 of the video game content with which an ambient light effect can be associated include, but are not limited to, background settings (day, night, outdoor, indoor, etc.), action sequences (e.g., car chases, explosions, fights, etc.), specific events (e.g., a character is born, a character goes to sleep or wakes up, a character dies, etc.). By way of example only, the lighting devices can generate a low light ambient light effect for an action sequence taking place inside of a dark room and switch to a bright light ambient light effect for a next action sequence taking place when the characters exit from the dark room to a sun-filled parking lot.

With reference to FIG. 4, another aspect of the method of the present invention is illustrated. FIG. 4 shows an exemplary digital video stream 30 representing video game content incoming from the video source 12 and being received by the gaming device 10. The digital video stream 30 representing the video game content includes a digital video file 32 and a digital audio file 34. In one approach, at least one portion of the video file 32 is a predetermined event or a scene in the video game content contained in the video file 32 that is associated with the at least one ambient light effect.

The digital video stream 30 also includes additional ALE tracks 36 including data specifying at least one ambient light effect associated with one or more portions or scenes of the video game contained in the digital video file 32. In one approach, the ALE tracks 36 include chrominance control data specifying at least one light color to be generated by one or more of the lighting devices 16 and 18 as will be discussed in more detail below. In another approach, the ALE tracks 36 can also include data specifying at least one lighting device (16, 18, or both) for generating the at least one ambient light effect specified in the ALE track 36.

When the digital video stream 30 is received by the gaming device 10 from the video source 12, the processor 13 performs the parsing of the digital video file 32 of the video content to separate one or more ALE tracks 36 and detect data representing one or more ambient light effects included in the ALE tracks 36. The processor 13 of the gaming device 10 is also programmed to perform the parsing of the ALE tracks 36 to detect the chrominance control data 38 contained in the ALE tracks as shown in FIG. 4.

The processor 13 of the gaming device 10 is also programmed to produce and send one or more commands one or more lighting devices to generate the one or more ambient light effects specified in one or more ALE tracks 36 and by the chrominance control data 38. For example only, the processor 13 can cause the gaming device 10 to send a first command 40 to the lighting device 16 to generate a first ambient light effect specified in the ALE track 36 and the chrominance control data 38, and send a second command 42 to the lighting device 18 to generate a second ambient light effect specified in the ALE track 36. The first and second ambient light effects produced based on the commands 40 and 42 may be the same or different.

The chrominance control data 38 can specify at least one color selected from red, green, blue, or combinations thereof. In an approach, the ALE tracks 36 can specify intensity of the colors specified by the chrominance control data 38. In another approach, the ALE tracks 36 can specify at least one of the lighting devices 16 and 18 for generating one or more light colors specified by the chrominance control data 38. In yet another approach, the ALE tracks 36 include a predetermined time when the one or more light colors specified by the chrominance control data 38 is to be generated by one or more of the lighting devices 16 and 18.

The lighting devices 16 and 18 can include hardware components 17 and 19, respectively. For example only, the hardware components 17 and 19 can be decoders programmed to interpret the chrominance control data 38 received in the commands 40 and 42, respectively, from the gaming device 10. In an approach, the hardware components 17 and 19 can be configured to cause the lighting devices 16 and 18, respectively, to generate one or more of the light colors specified by the chrominance control data 38. The lighting devices 16 and 18 may also include at least one software component adapted for interpreting the chrominance control data 38 received in the commands 40 and 42 from the gaming device 10. In one approach, the software component can be adapted to cause the lighting devices 16 and 18 to generate one or more of the light colors specified by the chrominance control data 38.

When the commands 40 and 42 from the gaming device 10 are received by the lighting devices 16 and 18, the lighting devices 16 and 18 generate the ambient light effects specified in the commands 40 and 42. As such, the ambient light effects specified in the ALE tracks 36 and the chrominance control data 38 are generated by the lighting devices 16 and 18, preferably, when the one or more portions of the video game content in digital video file 32 associated with one or more ambient light effects specified in the ALE tracks 36 and chrominance control data 38 are displayed to the user.

The generation of the ambient light effects including a variety of colors by the lighting devices 16 and 18 in association with various scenes, action sequences, and events specified in the ALE tracks 56 and chrominance control data 38 creates an enhanced and visually pleasing and interactive video gaming experience for a user.

As discussed above, in one approach, a graphical user interface is provided to a user to permit the user to configure one or more options for controlling the generation of the ambient light effects by the lighting devices shown in FIGS. 1-4. This advantageously results in a more personal and enhanced experience for each specific user during the users video gaming experience.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A method of controlling ambient light effects in video gaming, the method comprising:
providing a gaming device configured to parse incoming video game content;
receiving the video game content at the gaming device, the video game content including at least one track specifying at least one ambient light effect associated with at least one portion of the video game content;
parsing the video game content at the gaming device to separate the at least one track specifying the at least one ambient light effect and the at least one lighting device;
sending a command to generate the at least one ambient light effect specified in the at least one track from the gaming device to the at least one lighting device specified in the at least one track; and
causing the at least one lighting device receiving the command to generate the at least one ambient light effect specified in the at least one track when the at least one portion of the video game content associated with the at least one ambient light effect is displayed to a user.

2. The method of claim 1, wherein the gaming device is selected from one of a game console, a personal computer, a laptop computer, a tablet computer, and a mobile phone.

3. The method of claim 1, further comprising providing the gaming device including at least one hardware component programmed to parse the video game content to separate the at least one track specifying the at least one ambient light effect.

4. The method of claim 1, further comprising providing at least one software component adapted for inserting the at least one track specifying the at least one ambient light effect into the video game content.

5. The method of claim 1, wherein the at least one track further includes a predetermined location of the at least one lighting device relative to the gaming device.

6. The method of claim 1, wherein at least one track includes a predetermined time when the at least one ambient light effect is to be generated by the at least one lighting device.

7. The method of claim 1, wherein the at least one track includes at least one of brightness and rate of flickering of the at least one ambient light effect to be generated by the at least one lighting device.

8. The method of claim 1, wherein the at least one portion of the video game content is a predetermined event in a video contained in the video game content, the predetermined event being associated with the at least one ambient light effect.

9. The method of claim 1, further comprising providing a graphical user interface permitting a user to configure one or more options for controlling generation, by the at least one lighting device, of the at least one ambient light effect included in the at least one track.

10. The method of claim 1, wherein the sending a command from the gaming device to the at least one lighting device includes sending the command from the gaming device to the at least one lighting device via a wired connection.

11. The method of claim 1, wherein the sending a command from the gaming device to the at least one lighting device includes sending the command from the gaming device to the at least one lighting device via a wireless connection.

12. The method of claim 1, wherein the sending a command from the gaming device to the at least one lighting device includes sending the command from the gaming device to the at least one lighting device via a home automation system.

13. A method of producing an ambient light effect in video gaming, the method comprising:
providing a gaming device including a processor programmed to parse incoming video game content;
receiving the video game content including a plurality of scenes at the gaming device;
parsing the incoming video game content and detecting at least one scene in the video game content;
generating a command at the gaming device specifying the at least one ambient light effect to be associated with the at least one scene; and
sending the command from the gaming device to the at least one lighting device in communication with the gaming device to generate the at least one ambient light effect associated with the at least one scene when the at least one scene is displayed to a user.

14. The method of claim 13, wherein the detecting at least one scene in the video game content includes detecting at least one scene having a brightness level exceeding a predetermined threshold.

15. The method of claim 13, wherein the detecting at least one scene in the video game content includes detecting at least one scene having a brightness level below a predetermined threshold.

16. The method of claim 13, wherein the detecting at least one scene in the video game content includes detecting at least one scene having a sound level exceeding a predetermined threshold.

17. The method of claim 13, wherein the detecting at least one scene in the video game content includes detecting at least one scene having a sound level below a predetermined threshold.

18. The method of claim 13, wherein the detecting at least one scene in the video includes detecting an action in the at least one scene predetermined to be associated with the at least one ambient light effect.

19. The method of claim 13, wherein the generating a command specifying the at least one ambient light effect to be associated with the at least one scene further comprises including in the command chrominance control data specifying at least one color selected from red, green, blue, or combinations thereof to be generated by the at least one lighting device.

20. The method of claim 13, wherein the generating a command further comprises specifying the at least one lighting device for generating the at least one ambient light effect associated with the at least one scene of the video game content.
